(19) United States
(12) Patent Application Publication
(10) Pub. No.: US 2004/0205554 A1
(43) Pub. Date: Oct. 14, 2004

(54) Systems and methods for accessing multiple internal information sources of a business from a composite web document

(76) Inventors: Kumar K. Goswami, Sunnyvale, CA (US); Gabe Lawrence, San Jose, CA (US)

Correspondence Address: FISH & NEAVE, 1251 AVENUE OF THE AMERICAS, 50TH FLOOR, NEW YORK, NY, 10020-1105, US

(21) Appl. No.: 09/935,438

(22) Filed: Aug. 22, 2001

(51) Int. Cl. H04K 1/00; G06F 17/00

(52) U.S. Cl. 715/513; 705/76

(57) ABSTRACT

Systems and methods are provided for extracting information from various sources, including web pages and application programs. The systems and methods of the present invention provide a mechanism for accessing information from the various sources in a secure manner and for aggregating the information to create a composite document.

### FIELD OF THE INVENTION

The present invention relates generally to systems and methods for providing a customer with controlled access to information contained in internal documents, databases, applications, and other information sources of a business. The information is extracted from one or more sources and integrated into a composite document for display to the user, subject to authentication of the user and that user's authorization to access or use the sources of information.

### BACKGROUND OF THE INVENTION

For any but the smallest organization, businesses relationships tend to be relatively complex and involve many people, often from different departments within each organization. For example, a company may have relationships with its accountants, attorneys, customers, distributors, employees, financiers, manufacturers, retailers, and stock holders. The larger the number of people involved in a relationship, the more complex it becomes, and the harder it becomes to manage and maintain the relationship.

To address this difficulty, several computer systems have been developed for enabling host companies to manage their relationships with their customers or with other organizations. Typically these systems enable participants to exchange documents, send electronic messages, set up task lists, and perform similar operations. Various security mechanisms may also be used to restrict access to documents to authorized personnel. An example of a system used by a host company to manage its relationship and collaborative efforts with its suppliers is the Supplier Relationship Management (SRM) solution suite developed by i2 Technologies, of Dallas, Tex. An example of a web-based system that enables a host company to easily manage its business relationships with suppliers, customers, employees, and other third parties is described in co-pending, commonly owned, U.S. patent application Ser. No. 09/576,170, filed May 22, 2000, which is incorporated herein in its entirety.

While these systems provide useful tools that enable a host company to interact with other organizations, current systems typically lack a mechanism whereby a customer, supplier, or other third party may easily query internal systems of the host company, such as inventory and accounting databases. As a result, to obtain needed information from an internal system of a host company, a customer must first go through an employee of the host company who, in turn, queries the internal system and relays the results of the query to the customer. In addition, previously known systems fail to provide a mechanism whereby a host company can easily integrate or consolidate information from multiple sources into a single coherent document for a customer.

As an example, consider a customer inquiring into the status of an outstanding order to determine whether or not an order has been shipped and when the order is expected to arrive. If the order status information is available only through the internal systems of the host company, there is currently no means for a customer to access the information directly. Without an ability to query internal host company systems, the customer must contact an account manager at the host company, who in turn must access various internal systems to fetch the order information and report the order information to the customer. This process may be costly and time consuming.

Providing direct customer access to internal systems of a host company may be technically possible; however, it is likely to be undesirable, because, for example, not all customers can be entrusted with full access to such internal systems. Even assuming a customer is trustworthy, giving access to internal systems may increase the possibility that security may be inadvertently compromised.

Moreover, even if a customer had access to internal host company systems and databases, the information may be difficult to find. For example, information about what was ordered may be available from the host company's order processing system, whereas shipping information may be available through a different processing system. It is also likely that the order processing and shipping systems are implemented differently, have distinct user interfaces, and may require specialized knowledge to use them effectively. This problem is compounded when a customer has access to internal systems of multiple host companies.

Another consideration is that a customer may not necessarily want to have access to the internal systems of a host company because the customer may not be knowledgeable about the applications used by the host company and may not have the technical expertise required to query the applications to get the desired data. Furthermore, a customer may have relationships with multiple other organizations, and learning how to use the internal systems of each organization may be impractical. Therefore, there is a need for a tool that empowers a host company's customers, suppliers, and other third parties to directly get information from the internal systems of a host company.

These types of problems and difficulties may be overcome through extensive custom programming efforts. Common Gateway Interface (CGI) scripts can be written to extract data from various databases and application programs, and to assemble a web page based on the extracted data for display to a customer. For example, e-business organizations such as Amazon.com, from Seattle, Wash., have set up web pages from which customers can track the status of their order. Setting up and maintaining such custom systems, however, can be expensive, limiting their use to larger companies and organizations.

In addition to web-based solutions, several software packages are available for synchronizing multiple third-party applications. Such packages guarantee that the multiple applications can communicate with each other and ensure that data elements common to both are synchronized. Examples of such packages include the various business integration solutions developed by Tibco Software, Inc., of Palo Alto, Calif. These packages are often expensive to implement and adapt to the needs of a particular business. The high time and dollar cost limits the use of such packages to only large companies.

It is often the case that relevant information is not in a system maintained by either the host company or the customer. Rather, the information may be found at a third-party system. For example, a company that out sources product shipping and distribution to a third-party, such as FedEx®, may not have the latest shipping information. A customer may then need to get a shipping number from the host company and then access a system, such as a web site, maintained by the shipping company to determine an expected delivery date. The web-based solutions and software packages currently available are not designed to enable a customer, supplier, or other third-party to easily access internal data available in the multiple applications directly from the host company.

It would therefore be desirable to provide a tool for enabling a host company to easily set up and maintain custom web pages whereby customers can access internal systems of the host company.

It would also be desirable to provide a tool for enabling a host company to easily set up and maintain custom web pages whereby customers can access information from third-party systems.

It would also be desirable to provide a tool for aggregating information from multiple systems so that the information may be consolidated into a single document.

It would also be desirable to provide a mechanism whereby a customer can access internal systems of a host company without substantially reducing system security.

It would also be desirable to provide a tool to enable aggregate documents to be created and maintained by its users without extensive programming knowledge or expertise.

It would also be desirable to provide a system for gathering information from multiple sources and displaying the information to a user, wherein the system is easily extended or modified to provide new features and functionality at low cost.

It would also be desirable to provide a mechanism whereby once access to a third-party system has been developed by creating scripts, a business user rather than a programming expert can then specify what information will be available and who (a particular user or a group of users) will have access to the information.

### SUMMARY OF THE INVENTION

It is therefore an object of the present invention to provide a tool for enabling a host company to easily set up and maintain custom web pages whereby customers can access internal systems of the host company.

It is also an object of the present invention to provide a tool for enabling a host company to easily set up and maintain custom web pages whereby customers can access information from third-party systems.

It is also an object of the present invention to provide a tool for aggregating information from multiple systems so that the information may be consolidated into a single document.

It is also an object of the present invention to provide a mechanism whereby a customer can access internal systems of a host company without substantially reducing system security.

It is also an object of the present invention to provide a tool to enable aggregate documents to be created and maintained by its users without extensive programming knowledge or expertise.

It is also an object of the present invention to provide a system for gathering information from multiple sources and displaying the information to a user, wherein the system is easily extended or modified to provide new features and functionality at low cost.

It is also an object of the present invention to provide a mechanism whereby once access to a third-party system has been developed by creating scripts, a business user rather than a programming expert can then specify what information will be available and who (a particular user or a group of users) will have access to the information.

These and other objects of the present invention are achieved by providing systems and methods for extracting information from various sources, including web pages as well as html and other output provided by application programs, from a composite web document. The systems and methods consist of a software solution that enables business managers of a host company to set up information management centers for allowing customers, suppliers, and other third-parties to easily access information internal to the host company from a single composite web document. The information is typically available from multiple sources, including third-party applications used by the host company, and integrated into the composite document. The software solution performs the following functions: (1) accept a information query from a customer, supplier, or third-party; (2) access resources needed to answer the query; (3) retrieve the result of the query in a structured format; (4) parse the results to create a document model; (5) extract desired nodes from the document model; (6) and assemble the extracted nodes into an aggregate document.

In a preferred embodiment, the systems and methods of the present invention involve three main software components: (1) a web-based interface for enabling business managers to set up an information management center; (2) a family of scripts for extracting information from various information sources; and (3) a composite web document for enabling a customer, supplier, or other third-party to request and access information from the various information sources.

The web-based interface allows business managers to define which customers, suppliers, or other third-parties will be members of a given information management center and what type of access to information each member will have. Each member is said to have a “role”. Examples of roles include: ‘administrator,’ ‘editor,’ ‘contributor,’ and ‘reader’, among others. The information access depends on the role of each member. That is, a member assuming the role of a customer may not have access to payroll information, whereas a member assuming the role of a manager may have access to all information sources that store information internal to the host company.

Associated with each role are one or more scripts from a family of scripts developed by information technology personnel of the host company. The scripts are designed to quickly respond to information queries submitted by members of the information management center.

Advantageously, the present invention enables business managers to easily deploy scripts developed by information technology personnel for allowing customers, suppliers, or other third-parties to extract information from multiple information sources. The scripts are deployed according to the role of the customers, suppliers, or other third-parties. The information requested is aggregated into a composite web document, making the process of extracting information from multiple information sources transparent to the customers, suppliers, or other third parties.

### BRIEF DESCRIPTION OF THE DRAWINGS

The above and other objects of the invention will be apparent upon consideration of the following detailed description, taken in conjunction with the accompanying drawings, in which:

FIG. 1 shows an exemplary computer network useful in practicing the present invention;

FIG. 2 shows an illustrative login screen;

FIG. 3 shows an exemplary web page assembled from information extracted from multiple systems;

FIG. 4 is a simplified block diagram of a system in accordance with the principles of the present invention;

FIG. 5 is a conceptual flow chart of a process for assembling information in accordance with the principles of the present invention;

FIGS. 6 and 7 show how specific scripts from a family of scripts are selected in accordance with one embodiment of the present invention;

FIG. 8 is an exemplary interface for specifying role-based access to system features; and

FIG. 9 shows an exemplary tool for identifying a path to a node in the document object model of a document.

### DETAILED DESCRIPTION OF THE INVENTION

A web site comprises a collection of documents and information, along with a system of software programs and routines executing on a server for delivering the documents and information to be rendered for a user. As used herein, rendering data, such as documents, pictures, or other information, means to present the data to the user in a useful form. For example, text may be displayed on a computer screen, converted to speech and spoken aloud, or otherwise provided to a user.

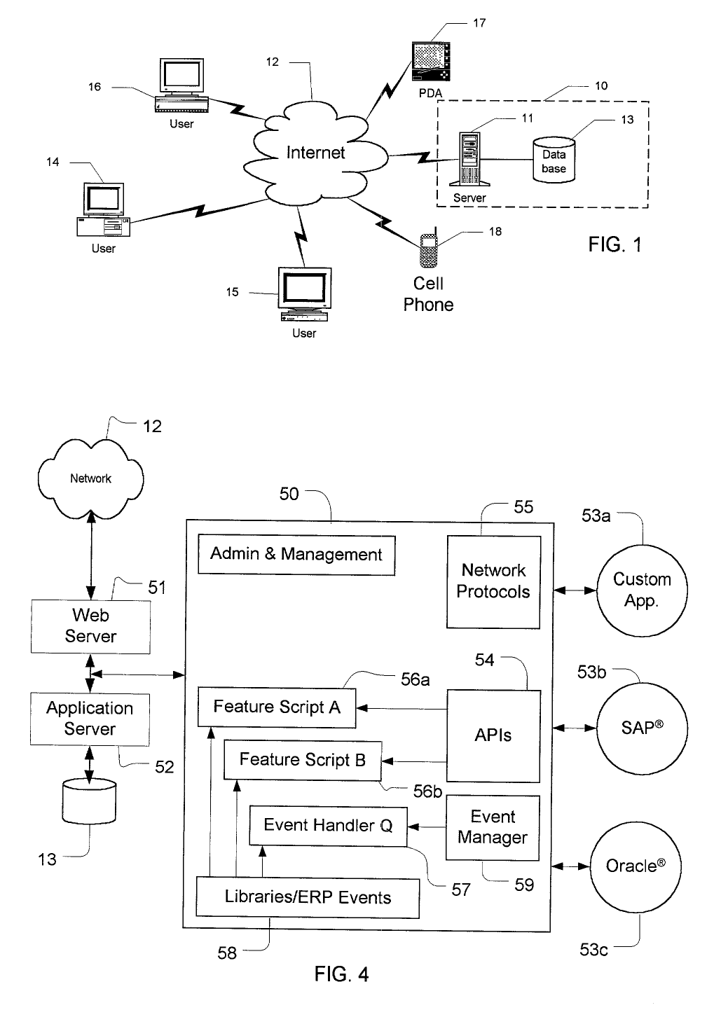

As shown in FIG. 1, system 10 includes server 11 which is coupled to network 12 so that users may access the web site from computers 14-16. Database 13, which may reside on server 11, or may be distributed across multiple servers, contains the information and routines used to process requests made by users of system 10. In a preferred embodiment, users access system 10 from computers 14-16 using web browser software, such as Netscape Navigator available from Netscape Communications Corporation of Mountain View, Calif. Other web browsers such as Internet Explorer from Microsoft Corporation of Redmond, Wash., may also be used.

Using a web browser as an interface to the system of the present invention leverages the ubiquity of Hypertext Markup Language (HTML) and the Hypertext Transport Protocol (HTTP) to provide truly global access. However, the system of the present invention is format-agnostic. That is, the system is not dependent on the use of HTTP and HTML so alternative interfaces may be used. For example, a document may be encoded using extensible Markup Language (XML) and sent to a user that is accessing system 10 using an Internet appliance or other device, such as Personal Digital Assistant (PDA) 17 or cellular telephone 18 of FIG. 1.

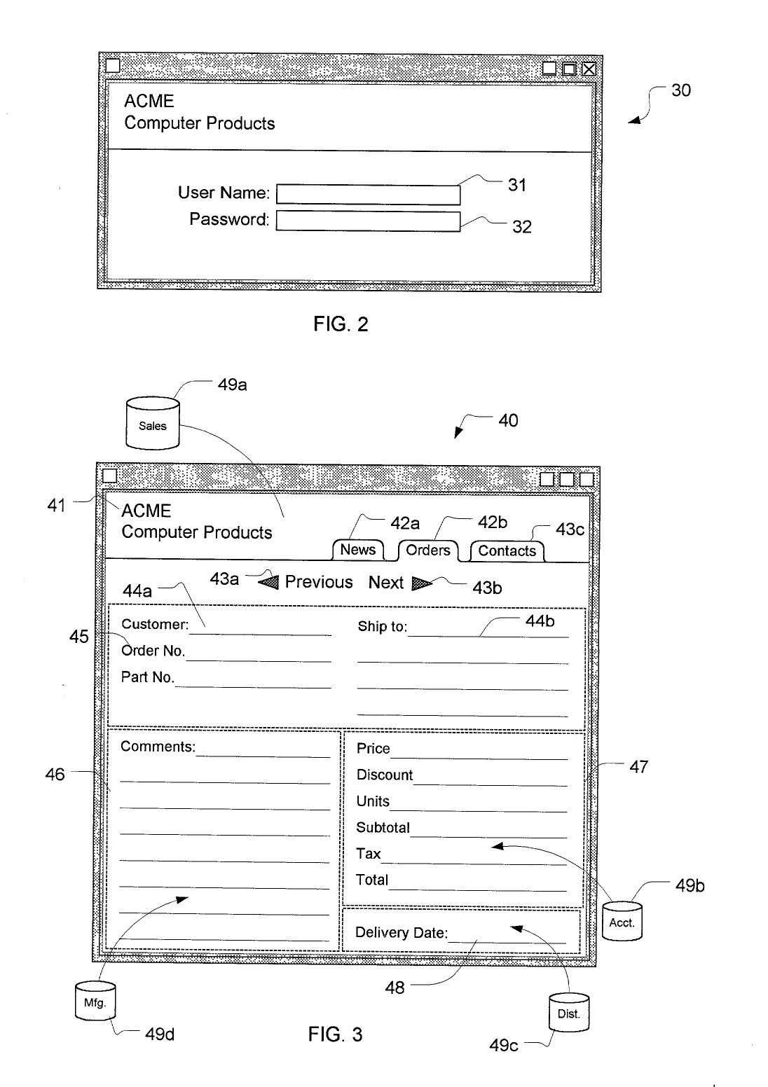

As described below, the functions and features available to a user of system 10 depends on the identity of the user. For this reason the identity of the user is authenticated prior to gaining access to the system. One such method of authentication may include providing a user name and password, as shown in FIG. 2. In such a method of authentication, a user enters a unique identifier, such as a user name, into text box 31 and a secret password in text box 32. The ‘login’ button is then activated by, for example, clicking on it with a mouse or other pointing device. System 10 then compares the user name and password with authentication information stored in system 10. If the user name and password are valid, then the user is granted access to system 10. In addition to the user name and password, the authentication information also contains information about the ‘role’ assigned to the user. Typical roles may include, for example, ‘administrator,’ ‘editor,’ ‘contributor,’ and ‘reader.’ In accordance with the principles of the present invention, the available roles may be fixed, or may be customizable and extendable.

FIG. 3 shows exemplary web page 40 assembled from document nodes obtained from various sources. Web page 40 includes, for example, host company logo 41, and controls 42a-c and 43a-b. Controls 42a-c represent folder tabs used to organize and categorize information available to a customer. Selecting a folder tab displays relevant information in the lower part of the web page. For instance, selecting folder tab 42a (“news”) may cause the display of important news events; whereas selecting folder tab 42c (“contacts”) causes contact information to be displayed.

Folder tab 42b (“orders”) is selected in the web page of FIG. 3 causing the status of outstanding orders to be displayed. The page shows information about an outstanding order. Control 43a (“next”) and control 42b (“previous”) may be used to view information about other outstanding orders. In accordance with the principles of the present invention, the order information is obtained from multiple sources and used to create web page 40.

Customer information, including name 44a and shipping address 44b, may be obtained from a customer database. Order information such as order number 45, as well as other information specific to individual orders, may be obtained from a sales application. Manufacturing may have a system for providing comments 46 on the status of manufacturing items to fulfil the customer order. Whereas information 47, including unit price, tax, shipping charges, and total price may be determined by an accounting application. Lastly, estimated delivery date 48 may be obtained from a computer system of a third-party shipping company.

A simplified block diagram of the architecture of a preferred embodiment of the present invention is shown in FIG. 4, including web server 51, application server 52, and database 13. Web server 51, executing on server 11 of FIG. 1, receives a request for a document via Internet 12 from a user at another computer. In a preferred embodiment of the present invention, the request is in the form of a Uniform Resource Locator (URL) formatted and transmitted in accordance with HTTP. Web server 51 responds to the requests by transmitting data in the form of a web page for rendering by a web browser, or other interface software, employed by the user. The documents are typically formatted using HTML and transmitted using HTTP, but other formats, such as XML, Wireless Markup Language (WML), and transport protocols, such as Wireless Application Protocol (WAP), may be used.

In accordance with the principles of the present invention, certain basic functions are provided by web server 51 and application server 52, as described in the U.S. patent application referenced above. Such basic functions may include, for example, contact lists, task lists, discussion groups, “what's new” features, and the like. These features and functions are provided by software on web server 51 and applications server 52 which are selected and executed by routines in web server 51. In accordance with the principles of the present invention, the features and functions provided by application server 52 may be extended and customized as described below.

There are a number of ways to dynamically create or alter the contents of a web page, including both client-side and server-side processing. In client-side processing, program routines are loaded and executed on the computer of a user, e.g., computer 15 of FIG. 1. The program routines may be embedded in a web page in the form of scripts, or may be stored separately from the web page and simply referenced in the web page markup. Common languages for embedding program routines include JavaScript and Visual Basic. Java applets, which comprise compiled routines in the form of byte codes, are invoked by a reference to the applet included in an web page. When the reference is detected by a user's web browser, the web browser downloads the applet and begins executing it.

In contrast, when using server-side processing, the programmed routines are executed by the web server, e.g., web server 51 of FIG. 4. The routines may be external scripts and programs accessed by using Common Gateway Interface (CGI) techniques. Other methods include using server-side directives, and embedding scripts or calls to Java servlets in the markup of a web page. Typically, server-side processing is used to access resources such as databases or applications external to the web server.

Server-side processing is performed by a servlet server embedded in web server 51. When web server 51 retrieves a web page to be transmitted to a web browser for display, the content of the web page is scanned for directives and scripts requiring server-side processing. For example a web page may include a reference to a servlet which is to be processed by the servlet server. The output of the servlet, if any, may be a dynamically created HTML document or a portion thereof.

In a preferred embodiment of the present invention, the Apache web server available on the Internet at http://www.apache.org/ is used to practice the present invention. In addition, the Tomcat implementation for the Java servlet and the Java Server Page technologies on top of Apache may be used in web server 51.

Web server 51 is coupled to application server 52 which may be located on server 11 with web server 51, or may be located on a separate computer connected to server 11 by a communications link such as network 12. Application server 52 provides a number of programs or routines that provide access to system features or that perform frequently used functions. For example, a routine on application server 52 may provide services to authenticate a user's ID and password during login. Suitable application servers for use in the present invention include JOnAS available from Evidian, of Louveciennes, France, or the Weblogic server from BEA Systems, Inc., of San Jose, Calif.

The present invention further includes database 13, which may be for example, a database provided by Oracle Corporation of Redwood Shores, Calif. Database 13 includes tables describing access permission and authority for users of the system, lists of documents stored on the system, and other information and data used to implement and administer the system. Depending on the needs of a particular host company and its customers, the contents of database 13 may be modified as needed. Access to database 13 is provided by routines on application server 52.

In operation, HTTP requests are sent to web server 51 from a web browser on a user computer, e.g., computer 14. The requests are sent via network 12 in response to a user action such as clicking on a control or link in a web page. In a preferred embodiment of the present invention, web server 51 parses the request and identifies a pair of cooperating servlets to carry out the request. A first servlet, called an application component, contains instructions for responding to the request. For example, an application component may contain instructions for retrieving data from multiple applications and assembling an aggregate document from the retrieved data.

The application component interacts with application server 52 to run software modules, called feature managers, that provide basic system functionality. For example, an Access Control List (ACL) manager may be used to provide basic access control functions used to determine whether a particular user has the authority to access a specific document.

A second servlet, called a presentation component, contains instructions for converting the output of the application component, if any, into a format suitable for displaying to the user. Typically, the output of the presentation component is an HTML document for display on a user's computer monitor; however, other formats may be used if the request originated from a device such as PDA 17 or cellular telephone 18. For example, a presentation component may provide text-to-voice translation so that responses sent to a cellular telephone may be read aloud to a user. Analogously, foreign language translators may be provided to enable readers or speakers of foreign languages to access the web site.

Although a host company may obtain, install, and maintain the tool described herein, in a preferred embodiment of the present invention, the components of the tool are provided as a service by a third-party service provider. The service provider supplies server 11 coupled to Internet 12, along with suitable software for implementing web server 51, including application server 52, and database 13.

Under the service model, host companies lease access to and use of the tool from the service provider. In an alternative embodiment, host companies license the software from the host company. The host companies then use the tool and system of the present invention to create web pages for their customers. For example, a disk drive manufacturer may lease these tools from a service provider and use the tools to create web sites for their customers.

As used herein, a host or host company refers to an entity using the present invention to provide their customers with customized web sites. The service and resources provided by the host are referred to herein as a domain. Customers or users refer to customers of a host. Database 13 includes tables that keep track of the hosts, customers, and domains. In connection with feature managers provided by application server 52 these tables keep separate domains provided by a common host, and to keep segregated the domains of multiple host companies.

The present invention is implemented through one or more scripts that are executed in response to user input to the system. Functions are attached to a control or link on a web page by referencing an appropriate script or applet in a URL associated with the HTML code that creates the control. When the control or link is activated the URL is sent to web server 51 where it is processed by a dispatch routine. In this manner, functions may then be invoked when a user activates a control or link such as by using a mouse to click on the control. For example, a script may be associated with Orders folder tab 42b of FIG. 3 using HTML code such as:

<A href=“http://www.url.com/dispatch.html?com
ponent=script/orders,action=functionName” . .
. > . . . </A>

Selecting Orders folder tab 42b then causes the URL:

http://www.url.com/dispatch.html?component=script/orders,action=functionName

to be sent to web server 51, wherein the “component=” parameter identifies a script to be executed, in this case, the script is called “orders.” The “action=” parameter is an optional parameter that specifies a specific function within the script execute. If there is no “action=” parameter, the main function in the script is invoked. A dispatch routine in web server 51 parses the URL and extracts the value of the parameters, e.g., “action.” The dispatch routine then invokes the script to be executed, e.g., the “orders” script, subject to the role of the user and the context of the request.

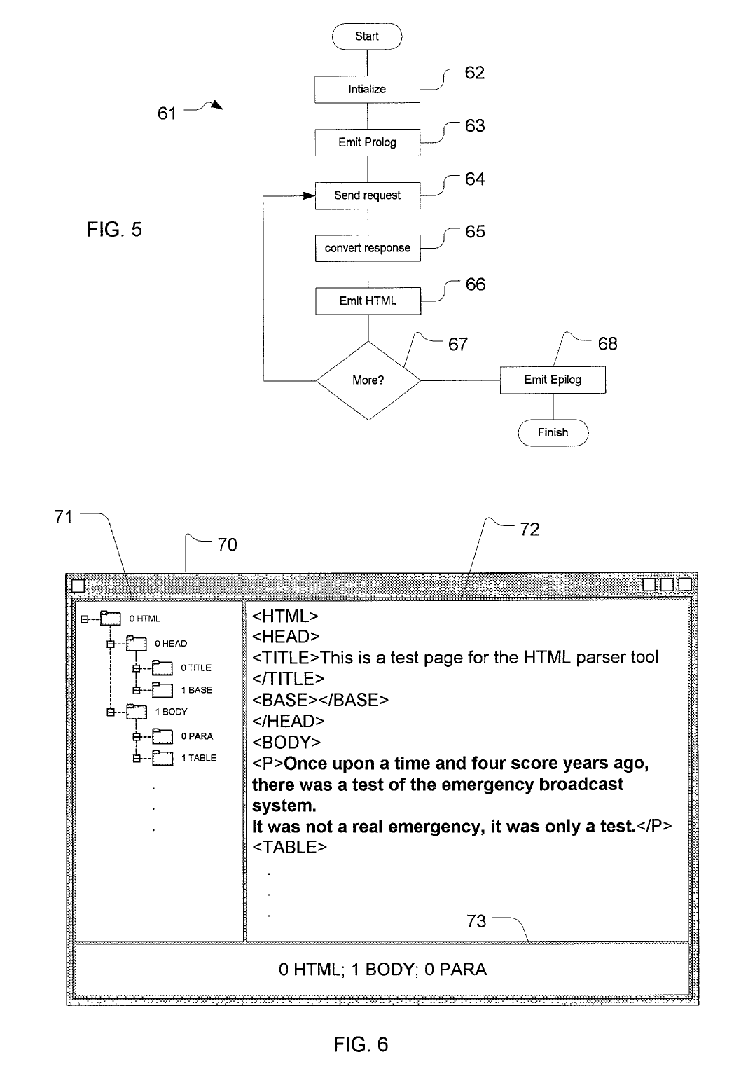

When a user activates Orders folder tab 42b, the dispatch routine of web server 51 determines the access permissions of the user and then calls the component identified in the URL. A component is an object that implements one or more features or functions, and is typically implemented as a collection of one or more related routines. The routines may be implemented as scripts, or as a program object, such as a Java class. If a needed component is not available, it is loaded by the dispatch routine and an initialization routine is called to make the component ready for use. Additional methods of the objects may then called to dynamically create an order status web page such as web page 30 of FIG. 3. A flow chart of an exemplary process for producing web page 40 is shown in FIG. 5.

A flow chart of an exemplary process for producing web page 40 is shown in FIG. 5. As described above in connection with FIG. 3, a dispatch routine is invoked in response to user activation of a web page control or link and passed a URL identifying a script to run or a component to activate. The dispatch routine identifies the script or component and, if needed, the component is first loaded and initialized at step 62. This may include emitting a prolog portion of the web page at step 63. The prolog may contain an initial portion of HTML code for the web page being constructed, such as the opening <html> tag, the <head> . . . </head> section, and the opening <body> tag. The html code actually emitted will depend on the application. For example, company logo 41, folder tabs 42a-c, and next/previous controls 43a-b may be contained in the prolog code for web page 30 shown in FIG. 3. One of skill in the art will understand that the code that emits the prolog HTML may be gathered into a separate routine or script.

After the prolog code is emitted the component, e.g. the “orders” component, calls additional scripts to retrieve whatever data and information is needed to create the content of the web page. In one embodiment of the present invention, the data is retrieved by forming an HTTP request and, at step 64, sending the request to an appropriate web server or application. At step 65 the response is received and converted to HTML, which is then emitted at step 66 as part of the HTML code for the page being built. If there is additional information or data to be extracted from other sources, additional requests are processed. Finally, any epilog html code is emitted at step 67, e.g., the </body> and </html> tags.

Information to be included in the created web page may come from a number of sources and may be provided in different formats. Some information may be obtained by sending an appropriate URL to another web server. For example, sites are available on the Internet that provide weather forecasts, traffic information, and stock market quotes. For this kind of information, an http request is created at step 64 in the form of a URL, and the request is sent to an appropriate web server. At step 65, an http response to the request is received and parsed so that the desired information may be extracted. The extracted information, which may include html formatting code, is then emitted at step 66 as part of the document being created.

As an example, some express delivery services provide mechanisms for tracking packages on their respective web sites. An appropriately constructed URL may then be used to query the delivery service web site. Typically, a response to such a query will include a web page in which the desired information is embedded. As described herein below, the web page may be parsed and the relevant information extracted for display to the user. In the web page of FIG. 3, for instance, delivery date 48 may be obtained by sending a query to the web site of an express delivery service, parsing the response to the query, extracting the relevant information, and inserting the information into the html code for creating web page 40.

The skilled artisan will understand that the flow chart of FIG. 5 provides a conceptual view of the process involved in creating a dynamic web page, and that such a process may be implemented in a number of ways. For example, the steps of FIG. 5 may be implemented by a function in a script, applet, or servlet. An exemplary function is provided in the following pseudocode:

function orderStatusInit( ) {

var doc = document.getDOMFragment (URL,path)
utility.beginLookAndFeel ( )
doc.traverse ( )
utility.endLookAndFeel ( )

}

Wherein getDOMFragment(URL,path) causes an http request to be sent to URL, a Document Object Model (DOM) of the response to be created, and the portion of the DOM identified by path to be extracted and stored in the variable doc. The calls to utility.beginLookAndFeel( ) and utility.endLookAndFeel( ) emit, respectively, prolog and epilog code and may establish the look and feel of the resulting web page. Doc.traverse( ) emits html code corresponding to the DOM fragment stored in the variable doc.

FIG. 6 shows exemplary DOM tool 70 used to identify portions of a document to be extracted and used in accordance with the principles of the present invention. DOM tool 70 includes DOM window 71, html window 62, and path window 73.

To use DOM tool 70, an html document, such as a web page, is loaded. The html code corresponding to the html document is displayed in html window 72. DOM tool 70 builds a DOM tree corresponding to the html and displays the tree in DOM window 71. A user may then select portions of the html document by selecting nodes in the DOM tree. DOM tool 70 highlights the corresponding portion of the html code in html window 72, and provides a path in path window 73 that uniquely identifies the selected portion of the document. The path information may then be used as an argument to the getDOMFragment() function as shown above.

Although some information is available through web pages, other information may be available through other applications. For instance, customer information 44a of FIG. 3, may be available from Oracle® database 53c of FIG. 4. Although many applications now support the use of HTML or XML to provide results, many applications and legacy code do not. For applications that provide results in html format, DOM tool 70 can be used to select the appropriate portion of the output for use in web page 40. For applications that do not provide html output, interface modules are used to translate queries into an application's native format and APIs (application programming interfaces), and to convert native output into html or XML formats. Referring back to FIG. 4, feature scripts 56a and 56b may use API's 54 to communicate directly with applications 52a-c. If an application is not local to interoperability engine 50, the query may be sent using network protocols 55.

In accordance with the principles of the present invention, scripts selected are for execution based on information in the URL sent to web server 51 and on the role assigned to the user. At a first level of operation, the role or the user determines whether a feature is available or accessible to that user. For example, a user that is assigned a role as an ‘engineer’ may not be permitted to view documents and information related to customer orders, whereas a salesperson may view order information, but not engineering blueprints and the like. Therefore, a user in a salesperson role would be shown ‘Orders’ tab 42b, whereas a user in an engineer role would not.

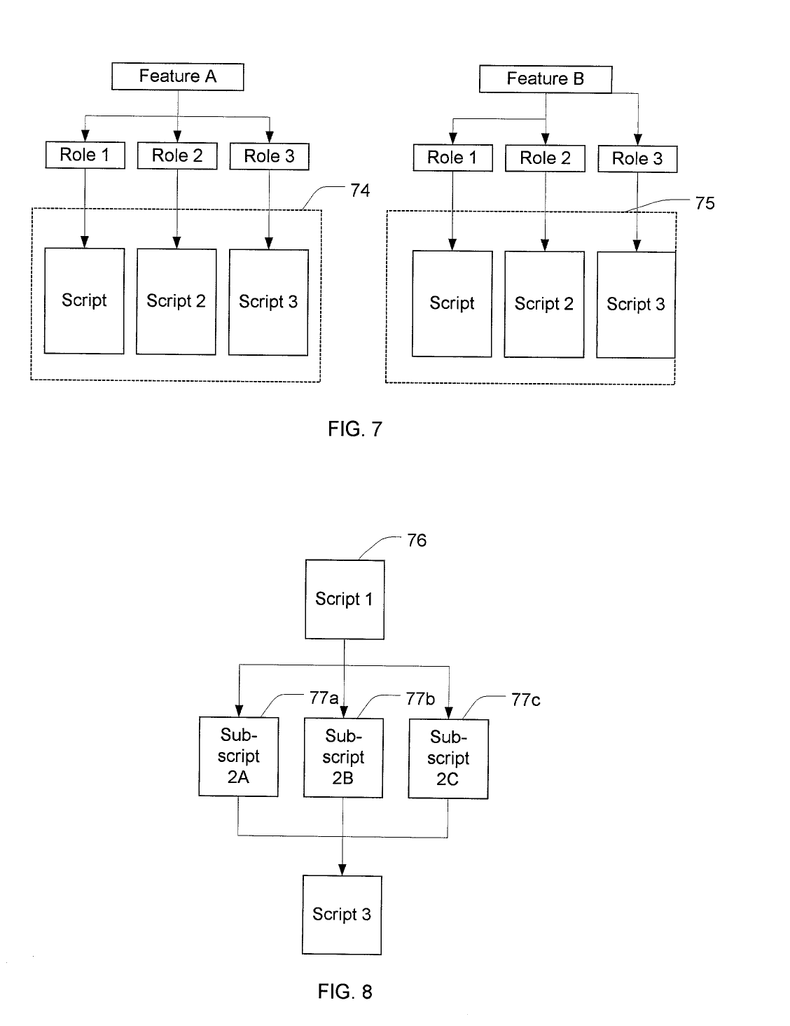

In one embodiment of the present invention, this is achieved by referencing a user's role from within the script and taking different actions depending on the user's role. However, in a preferred embodiment of the invention, this is accomplished through the use of role dependent script invocation. That is, the specific script executed by the dispatch routine is dependent on the role of the user. This is shown schematically in FIG. 7.

Each feature or function provided by the system includes an associated ‘family’ of scripts. The URL sent to the dispatch routine when a user activates a control identifies the ‘family’ of scripts or components to be invoked. For example, a first URL used to access feature A identifies family of scripts 74, whereas another URL used to access feature B identifies family of scripts 75. A table, which may be contained in a database, is then consulted. The table provides an index into the family of scripts that identifies specific scripts to execute depending on the role of the user. For example, if a user is in ‘role 2’, then script 2 is executed.

In a more preferred embodiment of the invention, the ability to execute scripts based on a user's role is extended to include the ability to execute such scripts based on the role of the user. This capability enables a system administrator to put common parts of the scripts into a single script that is executed regardless of the role of the user, while at the same time, role specific functionality is provided where needed.

This is shown schematically in FIG. 8, wherein common script 76 provides functions that are common to a number of different user roles. The dispatch routine executes common script 76 for each user. However, sub-scripts 77a-c provide role-specific functionality. Therefore, the dispatch routine looks up the appropriate sub-script to execute based on the user's role. When the role-specific function is complete, execution resumes with common script 76. One skilled in the art will appreciate that common and role-specific scripts may be combined in other ways to provide additional flexibility.

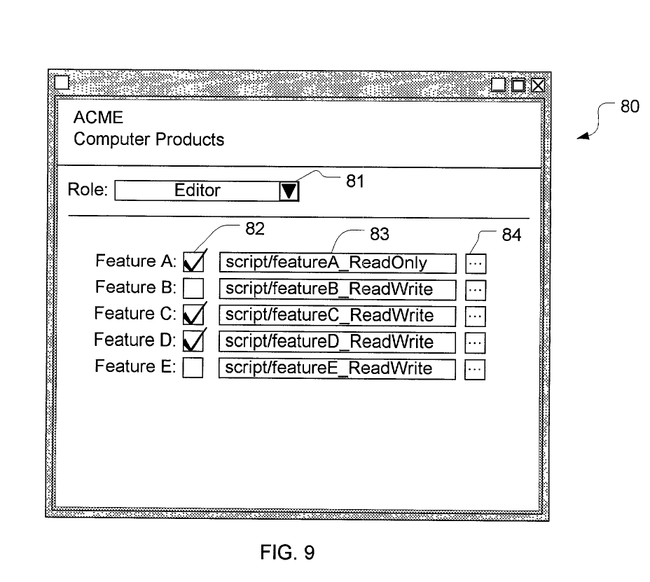

Yet another aspect of the present invention is the separation of the programming and administrative tasks. Scripts and components used to implement a feature or function are written to be independent of the user and of the user's role, and to be applicable to any user role. A system administration tool is then used to associate scripts with different user roles. An exemplary tool is shown in FIG. 9. An administrator selects a role from drop down list 81, and the available features are shown below. By clicking on check boxes 82, the administrator my make individual features available to users in the selected role, or may disable the feature for such users. In addition, for those features that have been enabled, text box 83 may be used to specify a script to be executed to implement the feature. Alternatively, button 84 may be selected to provide a browser style interface for selecting individual scripts.

It will therefore be understood by one skilled in the art that business managers may deploy the scripts from an easy-to-use interface without requiring any programming expertise. The scripts may be designed by information technology personnel of the host company. The business managers simply determine who will have access to the aggregate document and what scripts will be associated with which role.

Thus, a system for interfacing with one or more sources of information or providers of functionality and aggregating the information for rendering for a user is provided. One skilled in the art will appreciate that the present invention can be practiced by other than the described embodiments, which are presented for purposes of illustration and not of limitation, and the present invention is limited only by the claims which follow.

What is claimed is:

1. A method for providing a customer with controlled access to multiple sources of information a host company, the method comprising:
determining a role of the customer;
receiving a request for information from the customer;
retrieving the information from one or more of the multiple sources subject to the role of the customer;
aggregating the retrieved information into an aggregate document;
formatting the aggregate document for display to the customer;
sending the formatted aggregate document for rendering to the customer.

2. The method of claim 1, wherein the multiple sources comprise a plurality of databases, applications, and documents.

3. The method of claim 2, wherein at least one of the multiple sources is external to the company.

4. The method of claim 1, wherein the role of the customer comprises a set of access specifications and preferences governing the customer's access to information from the multiple sources.

5. The method of claim 1, wherein a request for information from the customer comprises a http or https request from a web page accessed by the customer.

6. The method of claim 1, wherein a request for information from the customer comprises a voice or keypad request on a cellular telephone used by the customer.

7. The method of claim 1, wherein a request for information from the customer comprises a request for information from an Internet appliance used by the customer to access a web page.

8. The method of claim 7, wherein the Internet appliance comprises one or more Internet appliances from a list consisting of: a personal computer; a notebook computer; a personal digital assistant; and a cellular telephone.

9. The method of claim 1, wherein the information comprises HTML or XML documents.

10. The method of claim 1, wherein the information comprises database queries.

11. The method of claim 1, wherein the information comprises function calls to an application program.

12. The method of claim 1, wherein retrieving the information from one or more of the multiple sources subject to the role of the customer comprises
determining a role of the customer;
determining whether the role is authorized to access a source; and
retrieving the information from the source if the role is authorized to access the source.

13. The method of claim 1, wherein retrieving the information from one or more of the multiple sources subject to the role of the customer comprises:
determining a role of the customer;
selecting a script based on the determined role of the customer; and
executing the selected script to retrieving the information.

14. The method of claim 1, wherein aggregating the retrieved information into an aggregate document comprises creating a custom web page to organize and categorize the retrieved information for the customer.

15. The method of claim 1, wherein formatting the aggregate document for display to the customer comprises formatting the aggregate document according to the Internet appliance used by the customer.

16. The method of claim 1, wherein sending the formatted aggregate document for rendering to the customer comprises downloading the custom web page to the Internet appliance used by the customer.

17. The method of claim 1, wherein sending the formatted aggregate document for rendering to the customer comprises sending a voice translation of the information to a cellular telephone used by the customer.

18. A method for a customer to access internal information of a host company on an Internet appliance from multiple information sources, the method comprising:
selecting a link on a web page for sending a request for internal information to a web server associated with the host company, wherein the link specifies a family of scripts for processing the request for internal information;
executing a script from the family of scripts to retrieve internal information from one or more multiple information sources and aggregate the internal information into an aggregate document;
formatting the aggregate document for access on the Internet appliance.

19. The method of claim 18, wherein the multiple information sources comprise a plurality of databases, applications, and documents.

20. The method of claim 18, wherein at least one of the multiple sources is external to the company.

21. The method of claim 18, wherein the Internet appliance comprises one or more Internet appliances from a list consisting of: a personal computer; a notebook computer; a personal digital assistant; and a cellular telephone.

22. The method of claim 18, wherein the information comprises HTML or XML documents.

23. The method of claim 18, wherein the information comprises database queries.

24. The method of claim 1, wherein the information comprises function calls to an application program.

25. The method of claim 18, wherein executing the script from the family of scripts to retrieve internal information from one or more multiple information sources comprises executing the script according to access permissions and preferences established for the customer by the host company.

26. The method of claim 25, wherein executing the script according to access permissions and preferences established for the customer by the host company comprises:
determining a role of the user;
selecting the script from the family of scripts responsive to the role of the user; and
executing the selected script.

27. The method of claim 18, wherein the aggregate document comprises a custom web page for organizing and categorizing the retrieved information for the customer.

28. The method of claim 18, wherein formatting the aggregate document for access on the Internet appliance comprises formatting the custom web page according to the Internet appliance used by the customer.

29. The method of claim 18, wherein formatting the aggregate document for access on the Internet appliance comprises sending a voice translation of the information to a cellular telephone used by the customer.

30. A system for providing a customer with controlled access to multiple information sources of a host company, the system comprising:
a web server including a family of scripts for handling a request for information from a web page accessed by the customer;
an application server comprising a plurality of software routines for monitoring the controlled access of the customer;
a plurality of information sources containing information pertaining to the host company;
an application component comprising a plurality of software routines for retrieving the information from one or more information sources of the plurality of information sources and for aggregating the information into an aggregate document; and
a presentation component for formatting the aggregate document for rendering to the customer.

31. The system of claim 30, wherein the multiple information sources comprise a plurality of databases, applications, and documents.

32. The system of claim 30, wherein the multiple information sources comprise third-party databases, applications, and documents.

33. The system of claim 30, wherein the information comprises HTML or XML documents.

34. The system of claim 30, wherein the information comprises database queries.

35. The system of claim 30, wherein the information comprises API calls into application programs.

36. The system of claim 30, further comprising a routine to identify a role of the customer and to execute scripts within a family of scripts responsive to the role of the customer.

37. The system of claim 30, wherein the web page accessed by the customer comprises a web page accessed on an Internet appliance.

38. The system of claim 37, wherein the Internet appliance comprises one or more Internet appliances from a list consisting of: a personal computer; a notebook computer; a personal digital assistant; and a cellular telephone.

39. The system of claim 30, wherein monitoring the controlled access of the customer comprises determining the information sources the customer has access to.

40. The system of claim 30, wherein retrieving the information from one or more information sources of the plurality of information sources comprises retrieving data from the multiple sources th at the customer has access to.

41. The system of claim 30, wherein aggregating the information into an aggregate document comprises creating a custom web page to organize and categorize the retrieved information for the customer.

42. The system of claim 30, wherein formatting the aggregate document for rendering to the customer comprises formatting the aggregate document according to the Internet appliance used by the customer.

43. The system of claim 42, further comprising downloading the custom web page to the Internet appliance.

44. The system of claim 42, further comprising sending a voice translation of the information to a cellular phone used by the customer.
